(19) United States
(12) Patent Application Publication
(10) Pub. No.: US 2023/0363322 A1
(43) Pub. Date: Nov. 16, 2023

(54) HORTICULTURE LUMINAIRE SYSTEM, DEVICES, AND METHODS

(71) Applicant: Peak Roots, Inc., Sisters, OR (US)

(72) Inventors: Theodore M. Thul, Pheonix, AZ (US); Darrin M. Dow, Sisters, OR (US)

(21) Appl. No.: 18/318,706

(22) Filed: May 16, 2023

Related U.S. Application Data
(60) Provisional application No. 63/342,541, filed on May 16, 2022.

(51) Int. Cl. A01G 7/04; A01G 9/20; F21K 9/238

(52) U.S. Cl. CPC A01G 7/045; A01G 9/20; F21K 9/238; F21Y 2115/10

(57) ABSTRACT

Horticulture luminaire panel assemblies for providing adjustable lighting to crops and associated systems and methods are disclosed herein. In some embodiments, a horticulture luminaire assembly includes an adjustable frame assembly carrying multiple luminaire panels. In some embodiments, a horticulture luminaire assembly includes luminaire devices mounted onto cross beams of a vertical grow rack. The luminaire panels can include an array of controllable lighting elements and a conformable lens that is dispensed directly over the lighting elements. The conformable lens can dissipate heat across the panel and protect the electronics of the panel from humidity and other corrosive climate conditions often found in indoor cultivation facilities, all while simulating natural light suitable for growth of organic products.

### CROSS-REFERENCE TO RELATED APPLICATION(S)

The present application claims the benefit of U.S. Provisional Patent Application No. 63/342,541, filed May 16, 2022, which is incorporated herein by reference in its entirety.

### TECHNICAL FIELD

The present disclosure generally relates to horticulture luminaire systems, devices, and methods. More specifically, the present disclosure relates to horticulture luminaire systems and luminaire panels.

### BACKGROUND

Indoor cultivation of crops is an expanding market as difficulties mount for outdoor cultivation. For example, unpredictability in weather and climate has made outdoor cultivation increasingly difficult as drought and storms starve or drown crops. Even mild unpredictability in weather and climate short of drought or storms has inhibited proper growth of certain crops requiring specific growing conditions. Further, outdoor cultivation is limited by the changing of seasons and location of the cultivation site, creating difficulties when attempting to grow crops to meet consumer demands in certain regions or by requiring extensive supply chains.

In addition, the market for indoor cultivation is further expanding given the efficiencies and predictability it can provide. For example, indoor cultivation can limit the impact of unpredictable weather, reduce the reliance on seasons and/or geographic regions, and increase the variety and viability of the plant selection pool. Despite growth and advantages of indoor cultivation, the indoor environment provides its own unique challenges and the equipment used to facilitate and manage it has not kept pace.

### BRIEF DESCRIPTION OF THE DRAWINGS

Many aspects of the present disclosure can be better understood with reference to the drawings in the following Detailed Description. The components in the drawings are not necessarily to scale. Instead, emphasis is placed on clearly illustrating the principles of the present technology. Reference numbers/indicators are used consistently throughout the drawings and description for ease to refer to items having similar structure, features, and/or functions. Identical reference numbers/indicators are not indicative that the items are identical.

FIG. 1A is an isometric view of a horticulture luminaire system suspended above a growing surface in accordance with embodiments of the present technology.

FIG. 1B is an isometric view of a horticulture luminaire system suspended adjacent to a growing surface in accordance with embodiments of the present technology.

FIG. 2 is an isometric view of a horticulture luminaire system configured in accordance with embodiments of the present technology.

FIGS. 3A-3D are side views of a horticulture luminaire system shown in different width and tilt arrangements in accordance with embodiments of the present technology.

FIGS. 4A-4C are front views of a horticulture luminaire system shown in increasingly larger width arrangements in accordance with embodiments of the present technology.

FIGS. 5A and 5B are front views of a horticulture luminaire system shown in increasingly larger length arrangements in accordance with embodiments of the present technology.

FIGS. 6A and 6B are back and front views, respectively, of a luminaire panel configured in accordance with embodiments of the present technology.

FIGS. 6C and 6D are enlarged front and isometric back views, respectively, of a connection port for a luminaire panel configured in accordance with embodiments of the present technology.

FIGS. 7A and 7B are cross-sectional side views of luminaire panels configured in accordance with embodiments of the present technology.

FIG. 8 is a flow diagram illustrating a method for manufacturing a luminaire panel, in accordance with embodiments of the present technology.

FIG. 9 is a flow diagram illustrating a method for manufacturing a luminaire panel, in accordance with embodiments of the present technology.

FIG. 10 is a front view of a luminaire panel assembly installed on a vertical grow rack in accordance with embodiments of the present technology.

FIG. 11A is an isometric top view of a luminaire panel system for a top layer of a vertical grow rack in accordance with embodiments of the present technology.

FIG. 11B is an isometric bottom view of luminaire panel system for an intermediate layer of a vertical grow rack in accordance with embodiments of the present technology.

FIG. 12 is an isometric view of a vertical grow rack system for luminaire panel assemblies configured in accordance with embodiments of the present technology.

### DETAILED DESCRIPTION

The present disclosure is directed generally to horticulture luminaire systems (“luminaire systems”) for indoor cultivation of plants and growth of organic products. Plants can include, for example, consumable crops, such as fruits, vegetables, grains, and tubers; medicinal crops; flowers; saplings; or any other similar plant and/or organic product suitable for indoor cultivation. The luminaire systems of the present technology may include features for improving plant cultivation indoors. For example, the luminaire system may include features such as a frame assembly supporting multiple luminaire devices (also referred to herein as “luminaire panels” or “luminaire panel assemblies”). The frame assembly may be adjustable, including width extension, length extension, and/or pivot mechanisms to modify or customize the luminaire system for the best application of light in different indoor cultivation applications. The luminaire panels can include an array of controllable lighting elements (e.g., LEDs) and a conformable lens that is dispensed directly over the lighting elements. The conformable lens can dissipate heat across the panel and protect the electronics of the panel from humidity and other corrosive climate conditions often found in indoor cultivation facilities, all while simulating natural light suitable for growth of organic products.

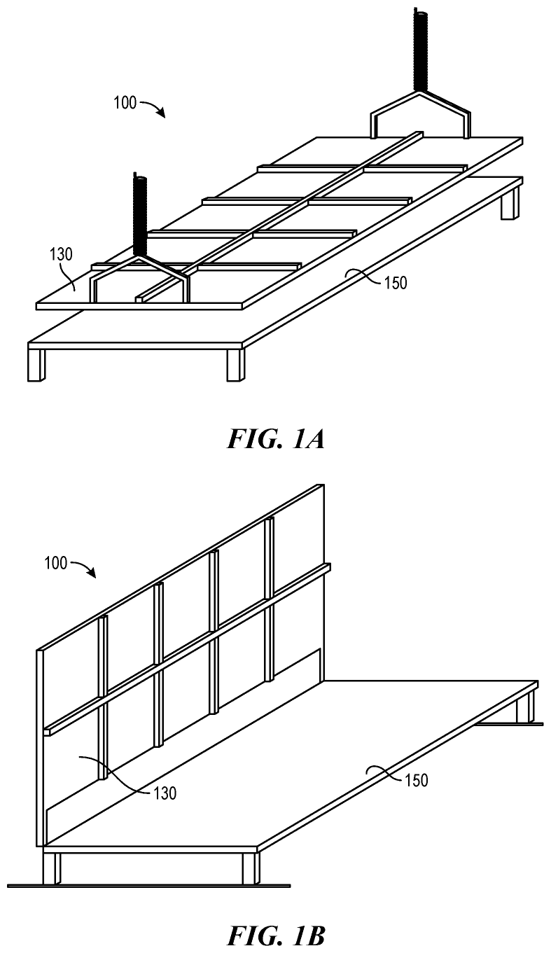

Specific details of several embodiments of the present technology are described herein with reference to FIGS. 1A-11C. Although many of the embodiments are described with respect to systems, devices, and methods for horticulture and indoor cultivation applications, other applications and other embodiments in addition to those described herein are within the scope of the present technology. For example, at least some embodiments of the present technology may be used for supporting cultivation devices in addition to luminaire panels, such as climate adjusting equipment (e.g., humidifiers, dehumidifiers, heaters); water lines or misters; fans; monitoring equipment or sensors; and/or other suitable equipment for use in indoor cultivation. Similarly, at least some embodiments of the present technology may be useful for lighting, supporting lights, or controlling lighting in non-cultivation settings. It should be noted that other embodiments in addition to those disclosed herein are within the scope of the present technology. Further, embodiments of the present technology can have different configurations, components, or procedures than those shown or described herein. Moreover, a person of ordinary skill in the art will understand that embodiments of the present technology can have configurations, components, or procedures in addition to those shown or described herein and that these and other embodiments can be without several of the configurations, components, or procedures shown or described herein without deviating from the present technology. The headings provided herein are for convenience only and should not be construed as limiting the subject matter disclosed.

### Select Embodiments of Horticulture Luminaire Systems

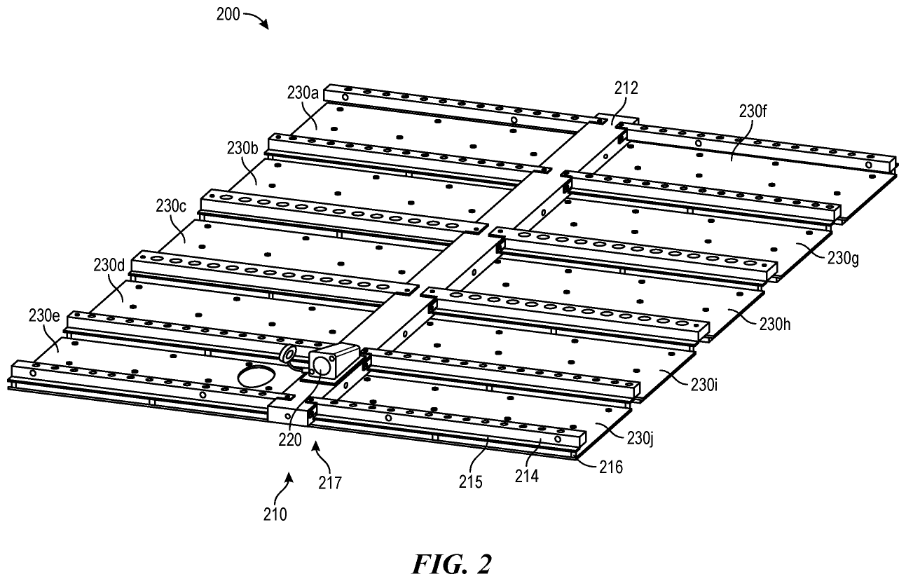

FIGS. 1A and 1B illustrate a horticulture luminaire system 100 (the “luminaire system 100”) positioned with respect to a growing surface 150 in accordance with embodiments of the present technology. FIG. 1A illustrates the luminaire system 100 oriented horizontally and suspend over the growing surface 150. FIG. 1B illustrates the luminaire system 100 oriented vertically and laterally adjacent to the growing surface 150. The luminaire system 100 can include multiple luminaire panels 130, each having controllable lighting elements that can provide tailored lighting for different species of plants. As described in further detail below with respect to FIGS. 2-5B, the luminaire system 100 can include features to adjust the system's width, length, and/or angle with respect to the growing surface 150 to provide the desired lighting arrangement for differently sized growing surfaces, differently oriented growing surfaces, different luminaire system applications, and/or different plants.

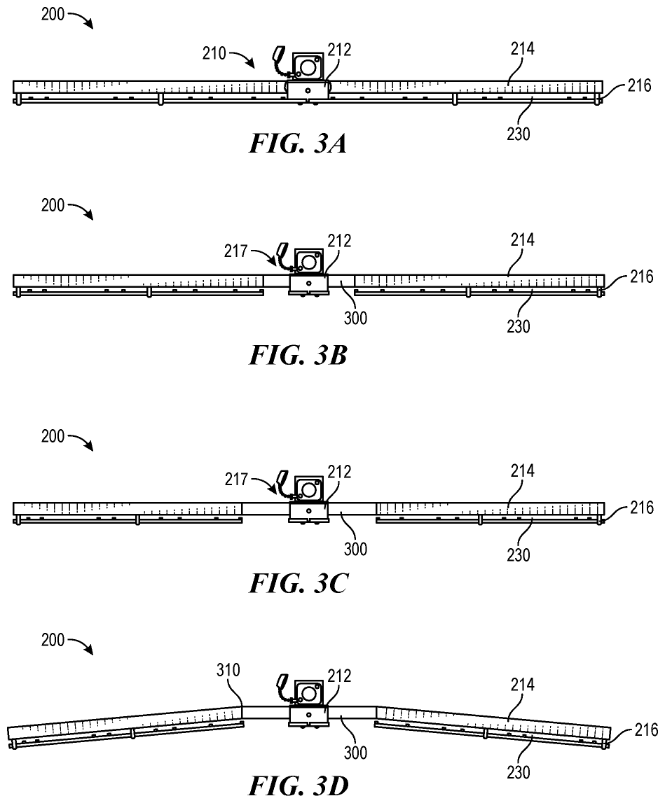

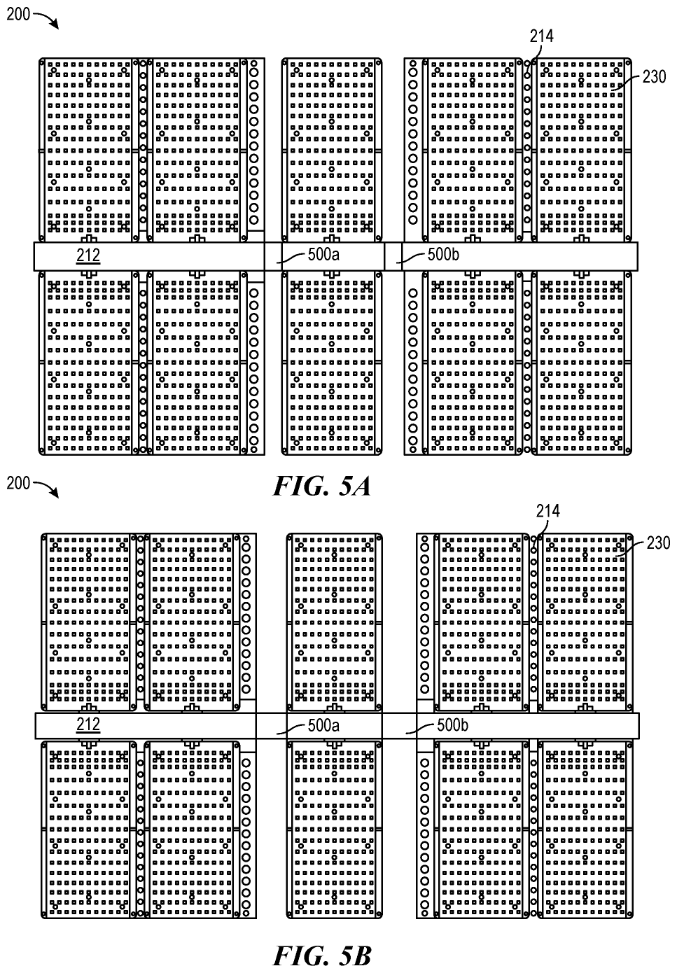

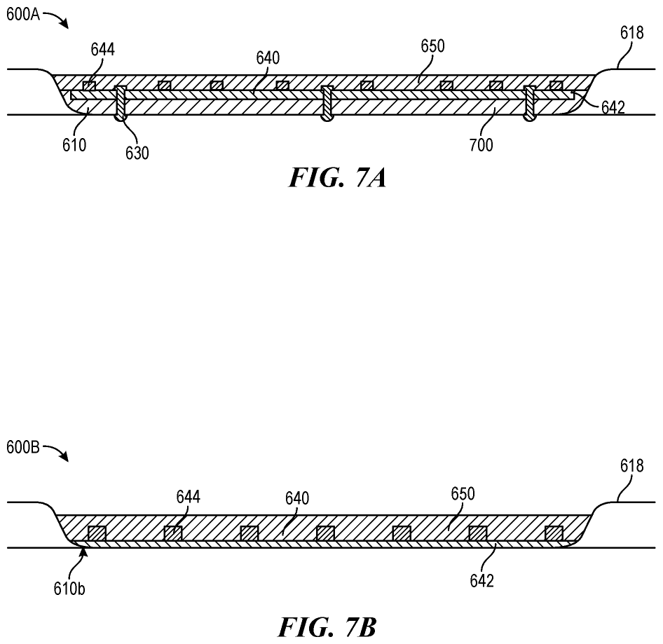

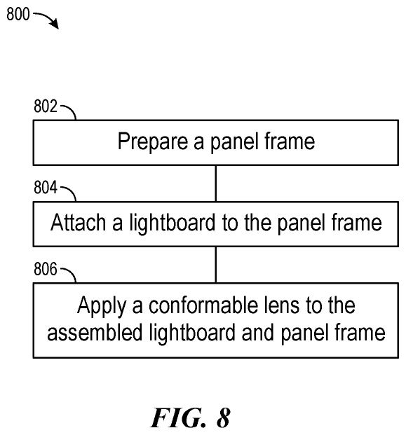

FIG. 2 is an isometric view of a luminaire system 200 configured in accordance with embodiments of the present technology. The luminaire system 200 can include the same or similar elements of the luminaire system 100 of FIGS. 1A and 1B and can be used in the same or similar environments. In the embodiment illustrated in FIG. 2, the luminaire system 200 includes a frame assembly 210 carrying a connection port assembly 220 and multiple luminaire panels 230 (identified individually as first through tenth luminaire panels 230a-230j, respectively). The frame assembly 210 can include a spine 212 and a plurality of arms 214 coupled to and extending laterally outward from the spine 212. In some embodiments the luminaire system 200 can further include one or more adjustment features to adjust the luminaire system's 200 width (as described in further below in relation to FIGS. 3B, 3C, 4B, 4C, and 6), length (as described below in relation to FIGS. 5A, 5B, and 7), and/or angle relative to the spine 212 (as described below in relation to FIGS. 3D and 8).

The spine 212 can be a support beam, an elongated plate, an elongated support shaft, and/or other suitable support structure that extends along a length of the luminaire system 200 between the laterally extending arms 214 and provides support for the structures extending therefrom and/or mounted thereon. In the illustrated embodiment, the spine 212 is centrally positioned between two sets of luminaire panels 230. In other embodiments, the spine 212 may be off-center or extend along a peripheral edge of the luminaire system 200 with luminaire panels extending only from one side. The spine 212 can have a length equal to the total combined length of the luminaire panels 230 extending therefrom, less than the total combined length of the luminaire panels 230, or greater than the total combined length of the luminaire panels 230. In some embodiments, for example, the spine 212 can have a length of 7.00 in to 70.00 in (17.78 cm to 177.80 cm; e.g., 46.00 in or 116.84 cm), or any incremental value therebetween or outside this range. In some embodiments, the spine 212 may have a channel extending through its length (e.g., a tubular structure, a hollow beam, a beam with one or more lumens) and, optionally, end caps at opposing ends of the spine 212. The spine 212 can be made from metal formed using an extrusion, stamping, bending, and/or similar process; a polymer constructed using an extrusion, molding, and/or similar process; other suitable support materials; and/or combinations thereof. In some embodiments, the luminaire system 200 may include one or more additional spines adjacent to or spaced from the spine 212 along the width of the luminaire system 200.

The arms 214 have a first end portion 217 coupled to the spine 212, extend laterally outward from the spine 212 to support one or more luminaire panels 230, and terminate at a second end portion (e.g., a free end). The number of arms 214 in the luminaire system 200 can depend, at least in part, on the quantity of the luminaire panels 230 in the system 200. In the illustrated embodiment, for example, the luminaire system 200 has six arms 214 extending from a first side of the spine 212 and six arms 214 extending from an opposing second side of the spine 212, and each set of six arms 214 supports five luminaire panels 230. In other embodiments, the luminaire system 200 can have fewer than six arms 214 on either side, more than six arms 214 on either side, different quantities of arms 214 on the first and second sides of the spine 212, no arms 214 extending from the first or second side of the spine 212, and/or arms 214 extending from additional sides of the spine 212. The length of the arms 214 can depend upon the dimensions of the luminaire panels 230 they support. For example, the arms 214 may have a length ranging from 10.00 in to 60.00 in (25.40 cm to 152.4 cm; e.g., 15.00 in or 38.10 cm), or any incremental value therebetween or outside this range. The arms 214 can be support beams, such as elongated channel beams, slotted channel beams, I-beams, T-bars, wide flange beams, L-angle beams, hollow beams, solid beams, and/or other suitable support structures. The arms 214 can include metal formed using an extrusion, stamping, bending, or similar process; a polymer constructed using an extrusion, molding, or similar process; other suitable support materials; and/or a combination thereof.

In some embodiments, each of the arms 214 include a spine coupling component at the first end portion 217 of the arm 214 and configured to align and couple the arms 214 to the spine 212. In the illustrated embodiment, the spine coupling component includes a flange extending outwardly from the arm 214 such that it can be positioned on a back surface of the spine 212, and a fastener can extend through the flange and into the spine to secure the arm 214 to the spine 212. In other embodiments, the arms 214 can be attached to the spine 212 using additional or other suitable structural attachment means, such as one or more fasteners, clip mechanisms, hooks, adhesives, or other similar features for securing the arms 214 to the spine 212.

As shown in FIG. 2, one or more of the arms 214 may include a flange 215 extending away from the main support structure (i.e., perpendicular to the length of the arm 214). These flanges 215 can include or carry one or more arm attachment features 216 that can secure the luminaire panels 230 to the arms 214. In the illustrated embodiment, the arm attachment features 216 include posts that extend perpendicular to the flange 215 and have threaded holes therein configured to receive a fastener (e.g., a threaded structure, such as a screw) extending through the luminaire panels 230. In some embodiments, the arm attachment features 216 may instead include fasteners, holes, clip mechanisms, hooks, adhesives, or other similar features for coupling the luminaire panels 230 to the arms 214.

The connection port assembly 220 is an electronics connection port or hub that can operably couple to one or more connectors that provide power to the luminaire system 200. In some embodiments, the connection port assembly 220 can also provide a connection to a software program and/or other electrical control signals that provide operating instructions to and/or receive operating information from the luminaire system 200. In the illustrated embodiment, the connection port assembly 220 is carried by a housing coupled to a back of the spine 212. In some embodiments, the connection port assembly 220 may be coupled to a front, a side, or an end of the spine 212, or the connection port assembly 220 may integrated into the spine 212 or arms 214, and the housing can be omitted.

The connection port assembly 220 may be in electrical communication with the luminaire panels 230 via wires and/or other electronic components extending through and/or along the spine 212 and/or the arms 214. Other electronic components within the spine 212 may include a system controller receiving power and operating instructions through the connection port assembly 220 to individually send to the luminaire panels 230. Any wires and electronic components within and/or on the spine 212 and/or the arms 214 may be jacketed or otherwise enclosed to protect from the indoor cultivation environment. Similarly, wires or electronic components extending from within to outside the spine 212 or the arms 214 pass through waterproof gaskets to prevent water from entering the spine 212 or the arms 214. In some embodiments, the luminaire system 200 may include one or more additional connection ports on the same or different sides of the spine 212 or on one or more arms 214. Further, the connection port assembly 220 and the one or more additional connection ports may be in electric communication with the same or different luminaire panels 230 and carrying power and/or operating instructions. In some embodiments, the operating instructions and/or other information can be communicated to the connection port assembly 220 and/or other features of the luminaire system 200 via a wireless connection (e.g., Wi-Fi, Bluetooth).

The luminaire panels 230 include a panel frame defining a back of the luminaire panels 230, a lighting assembly (also referred to as a “lightboard” or a “lighting component”) carried by the panel frame, and a lens over the light component and defining a front of the luminaire panel 230. The width of the luminaire panels 230 can be within a range of 2.00 in to 30.00 in (5.08 cm to 76.20 cm) and a width of the luminaire panels 230 can be within a range of 5.00 in to 60.00 in (12.70 cm to 152.40 cm), or any incremental value therebetween or outside these ranges, respectively. For example, in some embodiments, the width and length of the luminaire panels 230 are 7.22 in and 15.00 in (18.34 cm and 38.10 cm), respectively.

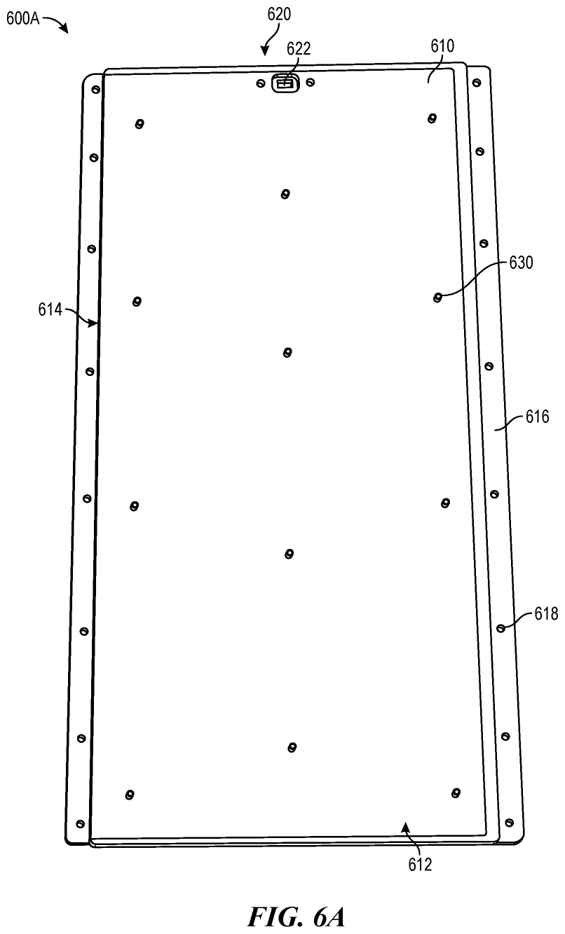

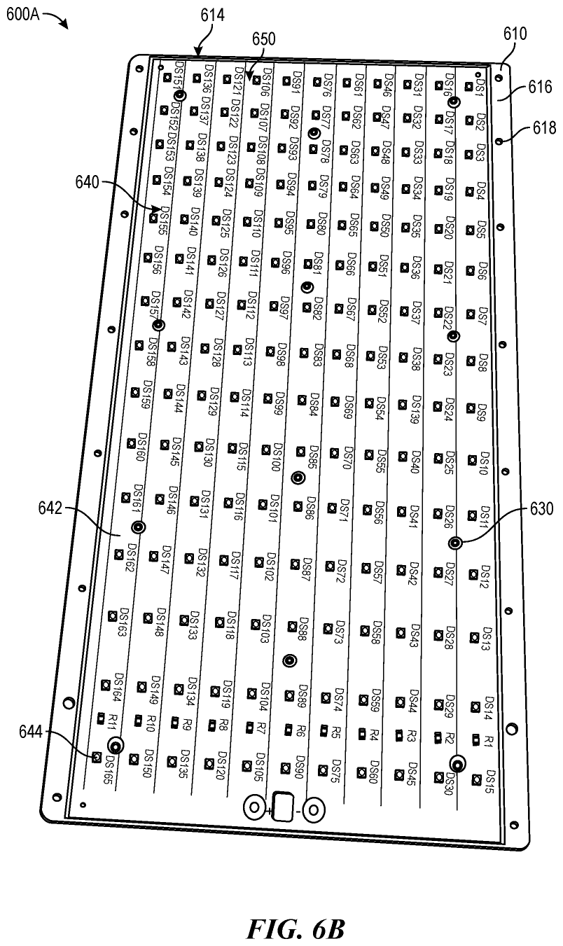

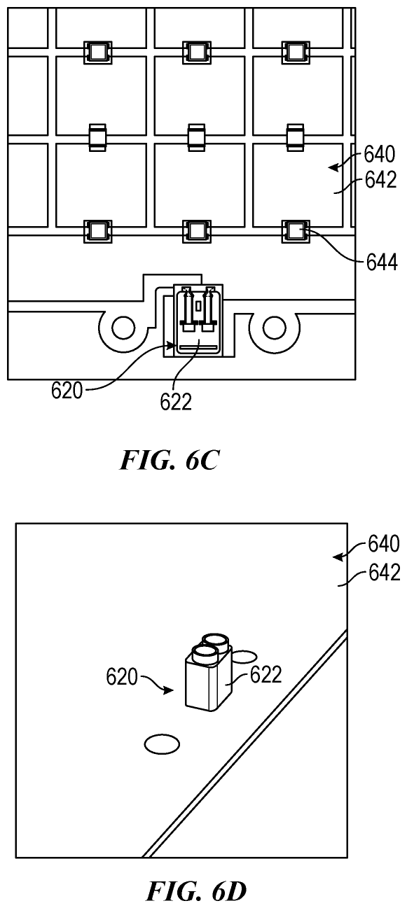

The light components of each luminaire panel 230 are in electrical communication with the connection port assembly 220 and can emit light from the front of the luminaire system 200 toward a growing surface. The lens covers the front of the light components and seals the light components from the environment surrounding the luminaire panel 230 and/or the chemicals or substances used or found in indoor cultivation. For example, the lens can seal the lightboard from moisture, pest and fungus fumigation or foggers, pesticides, fungicides, neem oil sprays, organic foliar sprays, mold, disinfectants and other cleaning chemicals, nutrients and corrosive chemicals, synthetic films, silver mulch, bacteria pathogens, and other similar substances used for indoor cultivation. As described in further detail below, in some embodiments the lens may be a conformable lens that is dispensed over the top of the light component. Further details of luminaire panels suitable for use with the luminaire system 200 of FIG. 2 are described below with respect to FIGS. 6A-7B.

In the illustrated embodiment, the luminaire system 200 includes ten luminaire panels 230 with five luminaire panels 230 arranged on either side of the spine 212. In some embodiments, the luminaire system 200 may include fewer luminaire panels 230 (e.g., 1, 2, 3, 4, etc.) or more luminaire panels 230 (e.g., 11, 12, 13, etc.) arranged in various manners along the sides of the spine 212 (e.g., 1×2, 2×2, 2×3, 3×3, 6×6, etc.).

The luminaire system 200 can be suspended horizontally over a growing surface or vertically adjacent to a growing surface by the spine 212 or the arms 214 of the frame assembly 210 depending on the indoor cultivation application and plants for growing. One or more connectors can be coupled with the connection port assembly 220 to supply power and operating instructions to the luminaire panels 230 supported by the frame assembly 210. In operation, the luminaire panels 230 can emit light that simulates natural light or enhances versions thereof from the front of the luminaire panels 230 with an evenly distributed light intensity to assist or facilitate plant growth on the growing surface. Further, the lens of the luminaire panel 230 can include features that extend the lifespan of the luminaire panel 230 by protecting the light component from the harsh features indoor cultivation environment.

### Selected Embodiments of Luminaire System Adjustment Features

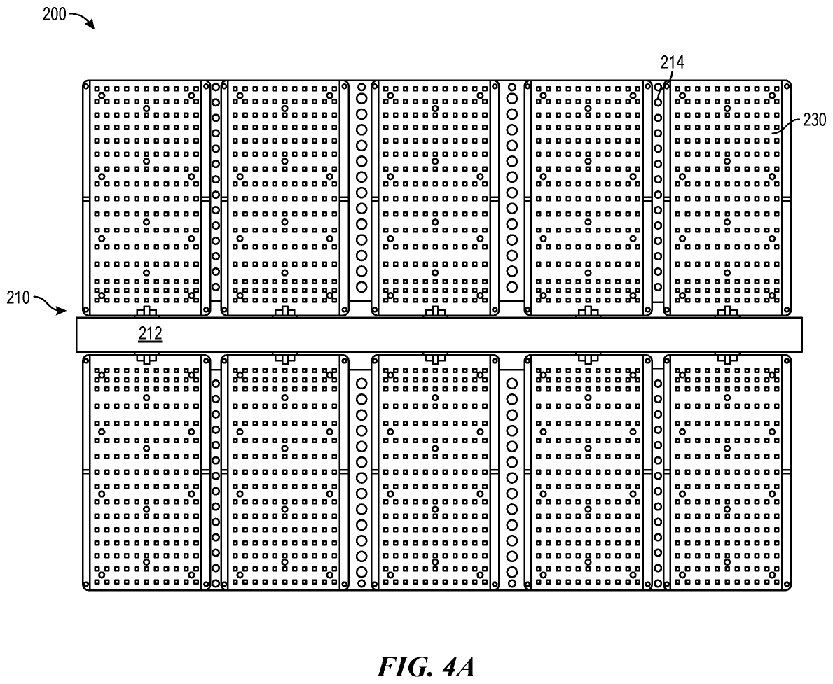

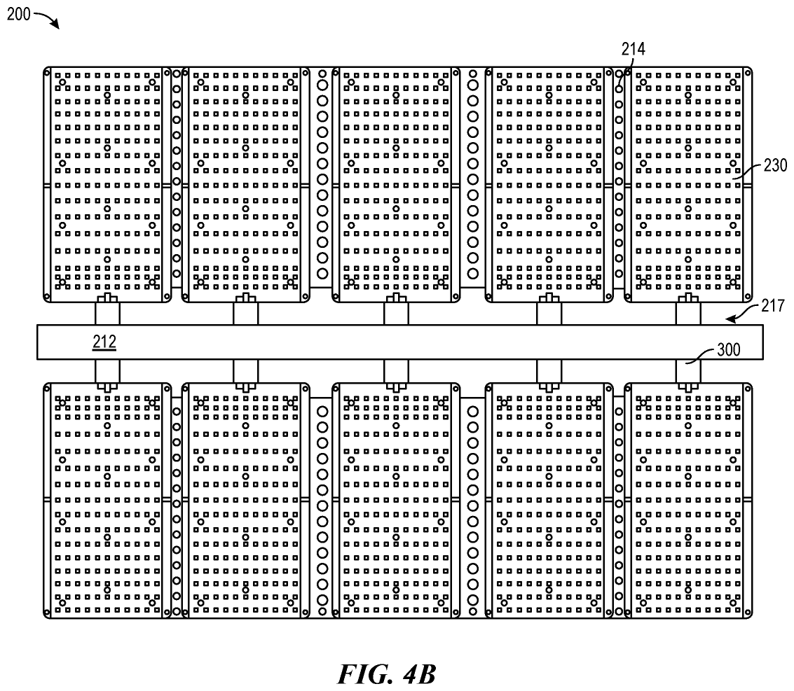

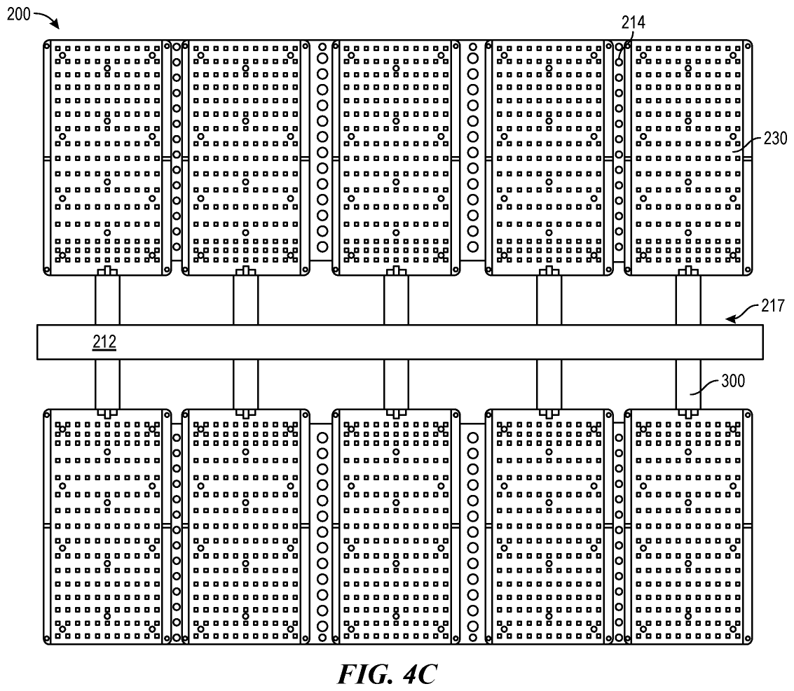

FIGS. 3A-5B illustrate the luminaire system 200 of FIG. 2 with the arms 214 in various states of width extension, length extension, and angular adjustment, in accordance with embodiments of the present technology. More specifically, FIGS. 3A-3D are side views showing width and pivot configurations of the luminaire system 200. FIGS. 4A-5B are front views showing width and length configurations of the luminaire system 200. For example, the luminaire system 200 can have adjustment features that allow the luminaire system 200 to move to one or more of the following configurations: (i) the compact configuration (FIGS. 3A, 4A; also referred to as a “first configuration,” “first state,” “unmodified configuration,” or the like), (ii) a first width extended configuration (FIGS. 3B, 4B), (iii) a second width extended configuration (FIGS. 3C, 4C), (iv) a first length extended configuration (FIG. 5A), (v) a second length extended configuration (FIG. 5B), and/or (vi) a pivoted configuration (FIG. 3D). These width extended, length extended, and pivoted configurations allow for luminaire system 200 modification or customization to suit different indoor cultivation applications for best plant growth.

Referring to FIGS. 3B, 3C, 4B, and 4C, the luminaire system 200 can include one or more width extension mechanisms 300 associated with one or more arms 214 and/or one or more luminaire panels 230 to space the luminaire panel 230 laterally outward from the spine 212 by a specified distance. In some embodiments, for example, the width extension mechanisms 300 can adjust in length to move the one or more luminaire panels associated therewith by up to 6 in (15.24 cm). When such width adjustment mechanisms 300 are coupled to luminaire panels 230 on either side of the spine 212, the width adjustment mechanisms 300 can adjusted together and/or individually to retractably extend the overall width of the luminaire system 200 by a desired distance (e.g., up 12 in (30.48 cm) or longer). In other embodiments, the width extension mechanisms 300 can have features that allow for lateral extension of less than 6 in (15.24 cm) or more than 6 in (15.24 cm). As shown in FIG. 3B, each of the width extension mechanism 300 extend between a corresponding luminaire panel 230 and the spine 212. The width extension mechanisms 300 can have a first end portion 217 that couples to the spine 212 and a second end portion opposite the first end portion 217 that couples with one or more arms 214, one or more luminaire panels 230, or one or more of both the arms 214 and the luminaire panels 230. The first end portion 217 and the second end portion of the width extension mechanisms 300 can be attached to the corresponding portion of the spine 212 or arm 214 using various attachment mechanisms, such as mechanical fasteners, clip mechanisms, hooks, adhesives, brackets, movable joints, hinges, and/or other attachment mechanisms. Any wires or electronic components within or on the spine 212 or arm 214 and coupled to the luminaire panel 230 can further extend through or along the width extension mechanisms 300 and can have excess length, contractability, and/or excess material to avoid subjecting the wires or electrical components to tension when the arms 214 are in extended states.

Each width extension mechanism 300 can include one or more components that can adjust in length and lock in place to position one or more of the luminaire panels 230 laterally apart from the spine 212. For example, the width extension mechanism 300 can include hinges and/or joints (e.g., knuckle joints) that couple together multiple components, telescoping features, and the like. In some embodiments, the width extension mechanism 300 may include multiple independent components that each correspond to a different width configuration. In these embodiments, a different component is used depending upon the length of width adjustment desired. For example, a first component can be configured to move the luminaire panel 230 laterally outward by up to 6 in (15.24 cm), and a second component can be configured to move the luminaire panel 230 laterally outward by more than 6 in (15.24 cm). In some embodiments, the width extension mechanism 300 can include first and second components that position the

In some embodiments, the width extension mechanism 300 may include a component that can extend outwardly and lock into place at various different widths. For example, the width extension mechanism 300 can include a combination of multiple, modular extension segments connected together. In some embodiments, the width extension mechanism 300 may correspond with different lengths of telescoping extension segments extending from the arms 214. In these embodiments, an elongated member may nest within the arms 214, or the arms 214 may nest within the elongated member, and include the coupling flange at a first end nearest the spine 212. The telescoping extension segments can be coupled to the arms 214 using one or more sliding mechanisms, such as, for example, drawer rails; can be coupled to the arms 214 using mechanical fasteners or pins extending through the arms 214 and the telescoping extension segments; or can be coupled to the arms 214 using any similar means allowing the telescoping extension segments to move along the length of the arms 214 and be secured to the arms 214 in one or more extension positions. In some embodiments, the telescoping extension segments may instead extend from the luminaire panels 230, the bracket, or a similar structure.

Referring to FIG. 3D, the luminaire system 200 can include a pivot mechanism 310 that can adjust the angle of the front surface of the one or more luminaire panels 230 relative to a plane extending longitudinally through the spine 212 and/or the growing surface. Specifically, the pivot mechanism 310 can rotate an arm 214 attached thereto about an axis at or near the first end portion 217 of the arm 214 to change the angle the front surface of one or more luminaire panels 230. The pivot mechanism 310 allows the luminaire panels 230 to be angled to and secured at one or more pivot positions. In some embodiments, the pivot mechanism 310 may be an independent component coupled between the arms 214 and the spine 212, between the arms 214 and the width extension mechanisms 300, or between the width extension mechanisms 300 and the spine 212. In some embodiments, the pivot mechanism 310 may be an integral component at the first end of the arms 214, an integral component at the first or second end of the width extension mechanisms 300, or an integral component of the spine 212.

Referring to FIGS. 5A and 5B, the luminaire system 200 can further include one or more length extension mechanisms 500 (identified individually as a first length extension mechanism 500a and a second length extension mechanism 500b) that can change the length of the spine 212 and the luminaire system 200 as a whole. The length extension mechanisms 500 can be positioned along the spine 212 between the arms 214 and/or the luminaire panels 230 such that extension of one of the length extension mechanisms 500 can separate two adjacent luminaire panels 230 by one or more predefined distances. For example, the length extension mechanism 500 can two adjacent luminaire panels 230 by between 1 cm and 40 cm, inclusive (e.g., 15 cm), or greater than 40 cm. In the illustrated embodiment, the luminaire system 200 includes two length extension mechanisms 500 that separate the luminaire panels 230 into three spaced apart sets. In some embodiments, however, the luminaire system 200 may include a single length extension mechanism 500 or more than two (e.g., 3, 4, etc.) length extension mechanisms 500, that may be positioned between two or more sets of luminaire panels 230. In some embodiments, the length extension mechanisms 500 can couple directly to the arms 214 and/or the luminaire panels 230.

The length extension mechanisms 500 can include, for example, structures that have a similar shape as the spine 212, are made of the same or similar materials, and coupled between sections of the spine 212 using brackets, mechanical fasteners, clip mechanisms, hooks, adhesives, or other similar features. Any wires or electronic components within or on the spine 212 and coupled to the luminaire panel 230 can further extend through or along the length extension mechanisms 500 and can include excess length or be extendable or contractable to avoid the application of tension along the wires or electronic components.

In some embodiments, the length extension mechanisms 500 may each include a single, independent component that can extend to one or more lengths and lock in place at the desired length. In some embodiments, the length extension mechanisms 500 may each include a combination of multiple, modular extension segments connected to the spine 212 and/or adjoining modular extension segments. In these embodiments, the length extension mechanisms 500 may be changed depending upon the number of modular extension segments.

In some embodiments, the length extension mechanisms 500 may include telescoping extension segments extending between sections of the spine 212. In these embodiments, an elongated member may nest within the section of the spine 212, or the spine 212 may nest within the elongated member, with the elongated member capable of movement along the length of the spine 212. The telescoping extension segments can be coupled to the spine 212 using one or more sliding mechanisms, such as, for example, drawer rails; can be coupled to the spine 212 using mechanical fasteners or pins extending through the spine 212 and the telescoping extension segments; or can be coupled to the spine 212 using any similar means allowing the telescoping extension segments to move along the length of the spine 212 and be secured to the spine 212 in one or more extension positions. In certain embodiments, each of the length extension mechanisms 500 extend to the same lengths and/or have similar structures, whereas in other embodiments the luminaire system 200 may include different types of extension mechanisms 500 and/or the extension mechanisms 500 may lengthen the spine 212 to varying degrees.

Luminaire systems 200 including the width extension mechanisms 300 and the length extension mechanisms 500 can be combined with the frame assembly 210 to increase the width and/or length of the luminaire system 200, respectively. The pivot mechanism 310 can be combined with the frame assembly 210 to adjust the angle (e.g., orientation) of the luminaire panels 230 with respect to the growing surface. Increasing the width or length of the luminaire system 200 and/or adjusting the orientation of the luminaire panels 230 can increase the area illuminated by the luminaire system 200. Additionally or alternatively, increasing the width or length of the luminaire system 200 or adjusting the orientation of the luminaire panels 230 can allow for illumination at select locations and, in some embodiments, spaced apart locations, such that the luminaire system 200 can provide a highly customized lighting layout based on the user's needs. The luminaire panels 230 can also be controlled independently of each other so as to customize the lighting arrangement based on the spacing and angular orientation of the luminaire panel to the growing surface and/or the plant needs. Further, these increases to the useable growing or light distribution can increase the efficiency and effectiveness of the luminaire system 200 for certain indoor cultivation applications.

### Selected Embodiments of Luminaire Panels

FIGS. 6A-7A illustrate a luminaire panel 600A configured in accordance with embodiments of the present technology. FIG. 6A is a back view of the luminaire panel 600A, FIG. 6B is a front view of the luminaire panel 600A, FIG. 6C is an enlarged front view of a connection port 622, FIG. 6D is an enlarged isometric back view of the connection port 622, and FIG. 7A is a cross-sectional side views of the luminaire panel 600A of FIGS. 6A and 6B. The luminaire panel 600A can include various features similar in structure and/or function as the luminaire panels 230 described above with respect to FIGS. 2-5B. Further, one or more of the luminaire panels 600A can be used in the luminaire systems 100, 200 described above.

Referring to FIGS. 6A-7A, the luminaire panel 600A includes a panel frame 610, a lightboard 640 carried by the panel frame 610, and a conformable lens 650 on a front surface of the lightboard 640. A back surface and/or side surfaces of the lightboard 640 can be coupled to the panel frame 610 with mechanical fasteners 630 (e.g., screws, nails, interfacing surfaces, clips) passing through holes in the lightboard 640 and panel frame 610 and/or an adhesive, such as a thermal paste 700. As described in further detail below with respect to FIG. 7B, the panel frame 610 defines the back of the lightboard 640 (e.g., the panel frame 610 defines the substrate on which the lightboard 640 is formed), eliminating the mechanical fasteners 630, the holes in the panel frame 610 and the lightboard 640 associated with the mechanical fasteners 630, and the thermal paste 700.

As illustrated in FIGS. 6A-7A, the panel frame 610 defines a back side of the luminaire panel 600A and includes a base 612 with sidewalls 614 extending at a non-zero angle or generally perpendicular therefrom. The base 612 has a rectangular shape, but in other embodiments the base 612 may be circular, oval, have different polygonal shapes, or have an irregular shape. As shown in FIG. 6A, the base 612 can include holes corresponding with holes in the lightboard 640 for the mechanical fasteners 630 to pass therethrough to engage with and secure the lightboard 640 to the panel frame 610. The sidewalls 614 can each extend from a side of the base 612 and collectively define an open cavity or pocket that is sized to receive the lightboard 640. The panel frame 610 can further include panel flanges 616 extending laterally outward from the front ends of one or more sidewalls 614. The panel flanges 616 include panel connection features 618 that provide for or facilitate attachment to an arm or spine of a luminaire frame assembly. For example, the panel connection features 618 can be holes where threaded fasteners can pass through and engage the arm attachment features 216 of FIG. 2 to secure the luminaire panels 600A to the frame assembly 210. A connection port access 620 extends through the base 612, providing access to a connection port 622 of the lightboard 640. The connection port access 620 can correspond in shape and location with the connection port 622.

The panel frame 610 can be made from metal with or without a coating or paint, such as, for example, aluminum, steel, and/or any similar metal for carrying a lightboard 640 in an indoor cultivation environment. The panel frame 610 can be formed using stamping, bending, or a similar process, and finished using welding or a similar process. For example, the panel frame 610 can include a single sheet of metal stamped to form a blank including a base portion, sidewall portions, panel flanges portions, and any cutaway portions of the panel frame 610, such as the panel assembly features 618, the connection port access 620, and any holes for the mechanical fasteners 630. The blank can be bent to form the sidewalls 614 perpendicular to the base 612 and to form the panel flanges 616 perpendicular to the sidewalls 614. A weld can be made at each corner of the bent blank to secure opposing edges of the sidewalls 614 together. As a further example, the panel frame 610 can include two or more sheet metal components stamped, or stamped and bent, and welded together to form or couple the sidewalls 614, the panel flanges 616, and the base 612 together.

The lightboard 640 includes a lightboard substrate 642, multiple light components 644 arranged in an array across the lightboard substrate 642, and multiple electrical lines within the substrate 632 that electrically connect the connection port 622 to the light components 644. The lightboard substrate 642 is a multilayer circuit board having a front side facing away from the panel frame 610 and a back side facing the panel frame 610. The lightboard substrate 642 can include a metal plate (e.g., an aluminum plate) on the back that acts as a heatsink to draw heat away from the lightboard 640. In some embodiments, the metal plate can be made from the same material as the panel frame 610 or from a material with similar thermal properties such that the two have similar responses to heating that occurs when the luminaire panel 600A emits light. The light components 644 are positioned at the front side of the lightboard substrate 642 and emit light outwardly, in a direction generally away from the back side.

The lightboard 640 can be coupled to the panel frame 610 by the mechanical fasteners 630 and the thermal paste 700. The mechanical fasteners 630 can include a metal shaft with a blind rivet on a first end and threading with a shoulder on a second end. The blind rivets extend through the holes in the lightboard 640 and are rivetted to secure the mechanical fasteners 630 to the lightboard 640. The second ends extend through the holes in the panel frame 610 with the shoulders resting on the panel frame 610 base. Threaded members, such as nuts, are coupled with the threading at the second end of the mechanical fasteners 630, securing the lightboard 640 to the panel frame 610. A thermal paste 700 fills the gap between the lightboard 640 and the panel frame 610. Heat can therefore pass through from the lightboard substrate 642 to the panel frame 610 through the thermal paste 700, using the panel frame 610 as a further heatsink for the lightboard 640.

In some embodiments, the mechanical fasteners 630 may instead be rivetted to the panel frame 610 and secured to the lightboard 640 using the threaded member. In some embodiments, the first and second ends of the mechanical fastener 630 may both include blind rivets or threading. Further, one or both ends of the mechanical fastener 630 can include any suitable means for securely coupling the lightboard 640 and the panel frame 610 together while providing a gap therebetween. In some embodiments, the mechanical fastener 630 may be integrally formed with either the panel frame 610 or the lightboard 640.

As illustrated in FIG. 6B, the lightboard 640 includes an array of the light components 644 arranged in a plurality of rows and columns across the front side of the lightboard 640 to emit light from the luminaire panel 600A. In some embodiments, the light components 644 can be arranged in a manner such that the luminaire panel 600A and/or a luminaire system (e.g., the luminaire system 200 of FIGS. 2-5B) including the luminaire panel 600A can emit light at an even or substantially even light distribution within a small distance from the front surface of the luminaire panel 600A, thereby providing substantially uniform light across a canopy grow area of plants towards which the light is directed. This even light distribution reduces or eliminates the presence of light concentration (e.g., hot spots) across the canopy grow area. Further, it allows the luminaire panel 600A to be mounted near the plants with a relatively small separation between the luminaire panel 600A and the plant canopy as it takes less distance for the emitted light to become substantially uniform. For example, in some embodiments the light components 644 can be arranged in a manner that allows the luminaire panel canopy grow area to be spaced as little as 6 in to 8 in (15 cm to 20 cm) from the grow canopy, whereas other known light panels require a separation of much greater magnitude (e.g., 18 in, 24 in).

To provide such substantially even light distribution, separation between the light components 644 can differ across the board, with the distance between light components 644 being smaller the further the light components 644 are from the center of the system (e.g., further from the spine) and the distance between the light components 644 being greater closer toward the center of the system (e.g., closer to the spine) (a “progressive arrangement”). In other words, a first subset of the light components 644 farther away from center of the system can have a greater density than a second subset of the light components 644 closer to the center of the system. For example, in the illustrated embodiment, the light components 644 are arranged in fifteen rows and eleven columns. The columns are evenly spaced along the width of the luminaire panel 600A. The rows are separated by a progressively smaller spacing along the length of the luminaire panel 600A. Therefore, when assembled in a luminaire system, the light component 644 rows further from the center (e.g., further from a spine) of the luminaire system are closer to one another. This progressive arrangement removes the effects of numerous overlapping emissions from the individual light components 644, which occurs more along the edges of adjacent luminaire panels 600A and does not occur along edges of the luminaire panel 600A defining the outer boundary of the lighting system.

In some embodiments, the light components 644 follow the progressive arrangement for a single luminaire panel 600A. For example, light components 644 can be more closely clustered (i.e., spaced apart from each other by a first distance) at peripheral portions of the lightboard 640 near the sidewalls 614 and spaced apart from each other by a second distance greater than the first distance at a central region of the lightboard 640. In some embodiments, the spacing between the light components 644 can decrease (continuously or incrementally) the further each light component 644 is from the center of the luminaire panel 600A. In these embodiments, for example, along any individual row or column of light components 644, the spacing between light components 644 is largest near the center of the luminaire panel 600A and smallest near the sidewalls 614. Further, rows or columns of light components 644 further from the center of the luminaire panel 600A can include more light components 644 than rows or columns closer to or intersecting with the center of the luminaire panel 600A. In some embodiments, light component 644 spacing is reversed and light components 644 are more closely clustered near the center of the luminaire panel 600A.

In further embodiments, the arrangement of the light components 644 across the individual luminaire panel 600A may correspond with an overall light component 644 arrangement for a luminaire system other than the progressive arrangement. For example, light components 644 across multiple luminaire panels 600A can be arranged such that light components 644 are clustered (i) centrally along the length of the luminaire system (e.g., light component 644 separation is smallest near the spine), (ii) along one or more sides of the luminaire system, (iii) near to or away from one or more corners of the luminaire system, or (iv) any other similar luminaire system-wide coordinated arrangement.

In some embodiments, the lightboard 640 may include an array with different quantities of light components 644, the light components 644 may be arranged in a different pattern (e.g., circular), and/or a combination of different patterns. In some embodiments, the light components 644 are evenly spaced apart from adjacent light components 644 across the array and light distribution controlled using light component 644 intensity=. In some embodiments, one or more rows or columns of the light components 644, or the light components 644 themselves, may be unevenly spaced from the adjacent row, column, or component. The light components 644 can be LEDs or other suitable light components that can be mounted on a circuit board.

Generally, light, watering, and fertilization for indoor cultivation are scheduled considering the slowest growing plants. Inconsistencies in growth therefore lead to over or under care for faster growing plants and loses in larger plant growth potential. By providing even light distribution over the canopy grow area using the progressive light component 644 arrangement, the luminaire panel 600A allows for uniform plant or other organic product growth and increased overall plant growth potential. Plants or other organic products have greater growth potential because uniform plants receiving even amounts of light have generally the same metabolisms. When a larger portion of plants on the growing surface have similar metabolisms, light, water, and fertilization scheduling can more accurately reflect the needs of each plant. With each plant received proper care, they are more likely to reach full growth potential and avoid the above noted losses.

Further, the progressive light component 644 arrangement of the luminaire panel 600A allows for greater indoor cultivation space efficiency, leading to greater plant and organic products output. Some luminaire systems attempt to provide even light distribution by using wide-beam lights, which require at least between 14 in and 18 in (35 cm and 41 cm) separation between the plants and the luminaire system. This necessary separation requires stacked growing surfaces (e.g., on shelves) to have significant unusable space therebetween. The progressive light component 644 arrangement of the luminaire panels 600A avoid the need for these wide-beam lights while simultaneously providing even light distribution at short separation distances. For example, luminaire panels 600A can be separated from plants thereunder or laterally adjacent thereto by 6 in to 8 in (15 cm to 20 cm). Therefore, the progressive arrangement requires less height between growing surfaces, allowing for more growing surface in the same amount of space, leading to better indoor cultivation space efficiency and overall plant or organic products output.

The conformable lens 650 extends directly over the light components 644 and covers the front side of lightboard 640. By covering the lightboard 640, the conformable lens 650 seals the lightboard 640 and, in particular, the light components 644 from the external environment. The conformable lens 650 is made from a translucent liquid that is poured onto the front surface of the lightboard 640, conforming to the front of the lightboard 640. As used herein, the term “translucent,” whether referring to a flowable liquid lens material or the cured lens, refers to a material that is either transparent or translucent. The conformable lens 650 can further flow around the lightboard 640 filling gaps between the lightboard 640 and the panel frame 610. The connection port 622 can remain uncovered by the conformable lens 650. Once poured, the conformable lens 650 can cure to a ridged or semi-ridged form, sealing the lightboard 640 from the external environment. The cured liquid lens material can remain translucent after curing. For example, the conformable lens 650 can include a flowable, translucent silicone material, such as a silicone DOWSIL coating and/or similar material. In certain embodiments, for example, the conformable lens 650 can include DOWSIL 1-2577 manufactured by Dow Corning of Midland, Michigan.

Referring to FIGS. 6C and 6D, the connection port 622 can extend outwardly from the back side of the lightboard 640 and protrude away from the panel base 612 (FIG. 6A) to allow for electrical connection to the lightboard 640. In some embodiments, the connection port 622 can be a quick connect electrical connector to ease connection. In some embodiments, the connection port 622 can be waterproofed so as not to be exposed to the moisture from irrigation of indoor growing environments. For example, the connection port 622 can be sealed in a structure with gaskets (e.g., a threaded gasketed structure) that is positioned around the exposed connection port 622 once the connection is in place.

During use, the luminaire panel 600A can illuminate a growing surface for more efficient and effective indoor cultivation. For example, the light components 644 can produce a controlled light from the front of the luminaire panel 600A directed at a growing surface to enhance or simulate natural light for indoor cultivation. Further, the luminaire panel 600A can provide a variety of financial and performance benefits over existing luminaire panels. For example, the conformable lens 650 can reduce manufacturing costs, materials, and time can because the conformable lens 650 can be applied directly to the front surface of the lightboard 640 in a single step. Typically, to qualify for UL for horticulture, a lighting panel requires an acrylic sealant to seal the lighting panel from the environment, and then a separate lens (e.g., made of polycarbonate, without a color shift) because the acrylic sealant does not qualify under UL. In contrast, the present conformable lens 650 provides both the sealing and lens function, and qualifies for UL, all in a single material without the need to provide a separate sealant and lens. In addition, the panel frame 610 can itself serve as the sleeve that retains the conformable lens 650 material as it flows over the luminaire panel 600A in its liquid form, removing the need for any additional manufacturing tools. Furthermore, the conformable lens 650 can seal the lightboard 640, including the circuitry therein and the light components 644 thereon, from the harsh horticulture environment to which it is exposed. For example, the conformable lens 650 provides an air and liquid proof seal, which is especially important in the humid horticulture environment where plants are subject to frequent watering. The conformable lens 650 can also seal and protect the lightboard from exposure to corrosive or otherwise problematic chemicals or substances used or found in indoor cultivation, such as pest and fungus fumigation or foggers, pesticides, fungicides, neem oil sprays, organic foliar sprays, mold, disinfectants and other cleaning chemicals, nutrients and corrosive chemicals, synthetic films, silver mulch, bacteria pathogens, and other similar substances. Additionally, the conformable lens 650 and the panel frame 610 can protect the lightboard 640 from excessive heat, also increasing luminaire panel 600A lifespan.

The conformable lens 650 can provide enhanced heat transfer properties. For example, current horticulture luminaires have a separate sealant and lens, which inherently creates small air gaps between the light components and the lens that result in excessive heat buildup in these air pockets. In contrast, the present technology uses the single flowable conformable lens 650 to provide both the sealing and lens features, which means the lens is disposed directly on the light components 644 in liquid form, thereby greatly reducing or eliminating the air gaps between the lens and the light components 644. The removal of air gaps can increase the longevity of the device as it avoids component failure caused by excessive heat. In addition, heat generated by the light components 644 of the disclosed luminaire panel 600A can transfer via conduction directly to the conformable lens 650 and from the conformable lens 650 to the surrounding environment. The panel frame 610 can also serve as a heatsink drawing heat away from the lightboard 640. Furthermore, the conformable lens 650 can provide superior shock absorption, which differs from known conformable acrylic sealants that become brittle and chip or crack.

FIG. 7B is a side cross-sectional view of a luminaire panel 600B configured in accordance with additional embodiments of the present technology. The luminaire panel 600B can include certain features similar to those of the luminaire panel 600A of FIGS. 6A-7A. For example, the luminaire panel 600B includes the lightboard 640, a panel frame 610b, and the conformable lens 650. In the embodiment illustrated in FIG. 7B, the panel frame 610b is integrally formed with the lightboard 640 and serves as the back plate or substrate of the lightboard 640. This eliminates the need for the steps and components used to attach the separate panel frame to the lightboard 640, such as thermally bonding and mechanically fastening the two together. The integrated panel frame 610b of FIG. 7B also removes the need for a separate aluminum back plate on the lightboard 640 and the thermal paste used to connect the aluminum back plate to the separate panel frame, thereby reducing the overall thickness of the luminaire panel.

### Selected Methods for Manufacturing Luminaire Devices

FIG. 8 is a flow diagram illustrating a method 800 for manufacturing a luminaire device, in accordance with embodiments of the present technology. For illustrative purposes, the method 800 is described with respect to the luminaire panel 600A of FIGS. 6A-7A, though the method 800 can be used to form other luminaire panels and devices. The method 800 includes preparing the panel frame 610 (process portion 802), attaching the lightboard 640 to the panel frame 610 (process portion 804), and applying the conformable lens 650 to the assembled lightboard 640 and the panel frame 610 (process portion 806). Preparing the panel frame 610 includes stamping the panel frame blank, bending and finishing the panel frame blank to form the panel frame 610, and applying the thermal paste 700 to the base 612 of the of the panel frame 610.

Stamping the panel frame blank includes stamping or cutting the panel frame blank from raw sheet metal. The panel frame blank includes the base portion, the sidewall portions, the panel flange portions, and any cutaway portions of the panel frame 610 such as the panel assembly features 618, the connection port access 620, and any holes for the mechanical fasteners 630. Bending to form the panel frame 610 includes bending the panel flanges 616 perpendicular to the sidewalls 614. Finishing the panel frame 610 includes welding adjacent sidewalls 614 together at each corner of the panel frame 610. Once the panel frame 610 is bent and welded, the thermal paste 700 can be applied to the base of the panel frame 610 avoiding any holes. In some embodiments, preparing the panel frame 610 can include two or more sheet metal components stamped, or stamped and bent, and welded together to form or couple the sidewalls 614 and the panel flanges 616 to the base 612.

Assembling a lightboard 640 to the panel frame 610 includes securing the mechanical fasteners 630 to the lightboard 640 and coupling the lightboard 640 to the panel frame 610 using the mechanical fasteners 630. Securing the mechanical fasteners 630 to the lightboard 640 includes passing the first end of the mechanical fasteners 630 through the holes in the lightboard 640 and riveting the mechanical fasteners 630 to the lightboard 640. Coupling the lightboard 640 to the panel frame 610 includes positioning the lightboard 640 above the thermal paste 700, aligning the second end of the mechanical fasteners 630 with the holes in the base 612 of the panel frame 610 and aligning the connection port access 620 with the connection port 622, and passing the second end of the mechanical fasteners 630 through the holes in the base 612. Once the second ends are through the holes in the base, the lightboard 640 is secured to the panel frame 610 with nuts at each mechanical fasteners 630.

In some embodiments, the mechanical fasteners 630 may instead be rivetted to the panel frame 610 and secured to the lightboard 640 using the threaded member. In some embodiments, the first and second ends of the mechanical fastener 630 may both include blind rivets or threading, or one or both ends may include any suitable means for securely coupling the lightboard 640 and the panel frame 610 together while providing a gap therebetween. In some embodiments, the mechanical fastener 630 may be rally formed with either the panel frame 610 or the lightboard 640.

Applying the conformable lens 650 to the assembled lightboard 640 and panel frame 610 includes preparing a conformable lens resin, pouring the conformable lens resin over the lightboard, and curing the poured conformable lens resin. Preparing the conformable lens resin includes preparing a translucent liquid (e.g., silicone DOWSIL sealant), polymer, and/or similar resin. Pouring the conformable lens over the lightboard includes pouring the liquid resin over the lightboard. Pouring the conformable lens can further include agitating the liquid resin or the panel frame to disperse the liquid resin evenly over the lightboard and between the lightboard and the panel frame. Curing the poured conformable lens resin can include allowing the liquid resin to sit and self-cure, directing a curing light at the liquid resin, heating liquid resin, or any similar method of curing a liquid resin.

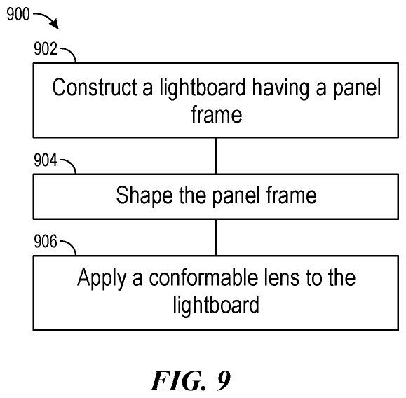

FIG. 9 is a flow diagram illustrating a method 900 for manufacturing a luminaire device, in accordance with some embodiments of the present technology. For illustrative purposes, the method 900 is described with respect to the luminaire panel 600B of FIG. 7B, though the method 900 can be used to form other luminaire panels and devices. The method 900 includes constructing the lightboard 640 having a panel frame 610b (process portion 902), shaping the panel frame 610b (process portion 904), and applying the conformable lens 650 to the front side of the lightboard 640 (process portion 906). Constructing the lightboard 640 can include forming the lightboard directly on a flat, oversized panel frame substrate. For example, the flat panel frame can serve as the substrate on which the lightboard is constructed. The panel frame can be larger than the lightboard such that flanges extend from two or more sides of the panel frame.

Shaping the panel frame substrate to form a panel frame 610 includes bending the flanges of the panel frame around the lightboard to form sidewalls 614 (and optional panel flanges 616) and securing adjacent sidewalls 614 together. Securing adjacent sidewalls 614 together includes welding or otherwise joining the corners of the panel frame 610 at adjacent sidewalls 614.

Applying the conformable lens 650 to the assembled lightboard 640 and panel frame 610 includes preparing the conformable lens resin, pouring the conformable lens resin over the lightboard 640, and curing the poured conformable lens resin. Preparing the conformable lens resin includes preparing the translucent liquid (e.g., silicone DOWSIL sealant), polymer, or similar resin for pouring over the lightboard 640. Pouring the conformable lens 650 over the lightboard 640 includes pouring the liquid resin over the lightboard. Pouring the conformable lens 650 can further include agitating the liquid resin or the panel frame 610 to disperse the liquid resin evenly over the lightboard 640 and between the lightboard 640 and the panel frame 610. Curing the poured conformable lens resin can include allowing the liquid resin to sit and self-cure, directing a curing light at the liquid resin, heating the liquid resin, or any similar method of curing a liquid resin.

### Selected Embodiments of Luminaire Panel Systems for Vertical Grow Racks

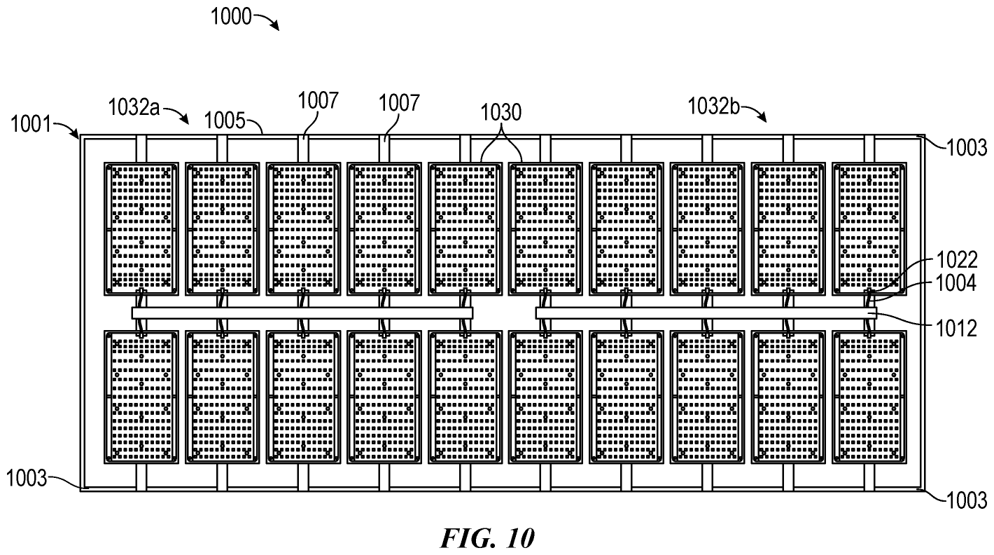

FIG. 10 is a front view of a luminaire panel system 1000 installed on a frame structure 1001 of a vertical grow rack in accordance with embodiments of the present technology. The luminal panel system 1000 (“system 1000”) can include numerous features similar to the luminaire panels and lighting systems described above with respect to FIGS. 1A-9. For example, the system 1000 can include a plurality of luminaire panels 1030 (e.g., the panels discussed above with reference to FIGS. 6A-7B) and one or more spine members 1012 having a channel or other lumen through which wires 1004 (e.g., for power, connectivity) can extend to electrically connect to the luminaire panels 1030 via, for example, the connection ports 1022. In contrast to the luminaire system 200 with the frame assembly 210 of FIG. 2, the luminaire panel system 1000 does not include a rigid frame structure carrying the multiple luminaire panels 1030. Instead, the luminaire panel system 1000 are suspended from the existing frame structure 1001 of the vertical grow rack 1001. For example, the individual luminaire panels 1030 and/or the spine 1012 can be secured to the existing vertical supports 1003 (shown extending perpendicular to the plane of the page), side support beams 1005, and/or cross-beams 1007 extending between the side support beams 1005 of the vertical grow rack 1001 to secure the wire harnessed luminaire panel system 1000 above a grow tray. In the illustrated embodiment, the luminaire panels 1030 are attached to the cross-beams 1007, though the panels 1030 may alternately or additional be attached to the vertical supports 1003 and/or the side supports 1005.

In the illustrated embodiment, the luminaire panel system 1000 includes two luminaire panel assemblies 1032 (identified individually as a first luminaire panel assembly 1032a and a second luminaire panel assembly 1032b), each having ten luminaire panels 1030, with five panels 1030 positioned on each side of the spine 1012, and wires 1004 extending from the spine 1012 to each panel 1030. In some embodiments, each luminaire panel assembly 1032 can have fewer than or more than ten luminaire panels 1030 and/or the luminaire panel assemblies 1032 along each grow rack level (e.g., shelf) can have different numbers of luminaire panels 1030. In some embodiments, a single luminaire panel assembly 1032 can extend across an entire grow rack shelf or more than two luminaire panel assemblies 1032 can be used on a single level. The luminaire panels 1030 of each luminaire panel assembly 1032 can be electrically connected in series or in parallel. In some embodiments, the luminaire panels 1030 can be wired such that the panels 1030 of each assembly 1032 are controlled together (e.g., from a single power source). In some embodiments, each panel 1030 or subsets of the panels 1030 can be electrically coupled separately such that individual or groups of panels 1030 can be controlled independently of each other.

The spine members 1012 of each luminaire panel assembly 1032 have a channel through which the wires 1004 extend. The wires 1004 can be waterproofed (e.g., jacketed, coated, surrounded in rubber, plastic, or other material) to withstand indoor grow environments. The spin2 1012 can be an elongate, tubular structure composed of plastic, metal, or other suitable materials for supporting the wires 1004. In some embodiments, the spine 1012 can have a different shape depending on how the configuration of the luminaire panels 1030. In some embodiments, the spine 1030 can support additional devices or features, such as sensors or cameras, and/or electrical wires associated therewith.

As shown in FIG. 10, the vertical grow rack 1001 includes vertical supports 1003 at each of the four corners, the side support beams 1102 connecting the vertical supports 1003, and multiple cross beams 1007 extending across the side support beams 1005 at a generally perpendicular angle. In some embodiments, the vertical grow rack 1001 can include additional side support beams 1005, cross beams 1007, and/or vertical supports 1003. The cross beams 1007 can be secured to a bottom lip areas of opposing side support beams 1005 via fasteners, welding, interfacing surfaces, and/or other coupling mechanisms. The vertical supports 1003, the side support beams 1007, and the cross beams 1005 can be composed of metal (e.g., steel), plastic, and/or other suitable materials for supporting grow decks, associated irrigation, and the luminaire panel system 1001. The vertical supports 1003, side support beams 1005 and/or the cross beams 1007 can be part of a standard shelving unit and the luminaire panel assemblies 132 can be attached or suspended therefrom using the already existing structure of the standard shelving, and thereby allowing the luminaire panel assemblies 1032 to conveniently fit into existing grow decks and standardized shelving structures.

In the illustrated embodiment, the luminaire panels 1030 are arranged in two rows such that each luminaire panel 1030 is mounted to one cross beam 1005, each cross beam 1005 supports two luminaire panels 1030, and the spin 1012 is optionally mounted to one or more cross beams 1007 between the two rows of panels 1030. As described in further detail below, the luminaire panels 1030 can be attached to the cross-members 1007 using various different attachment mechanisms, such as braces, connector knobs, interfacing surfaces, screws, and/or other fastening mechanisms. In some embodiments, the luminaire panels 1030 and the spines 1012 can be arranged in a different configuration.

In some embodiments, each luminaire panel assembly 1032 may cover a four feet (1.22 m) by four feet (1.22 m) area. For example, the two assemblies 1032 illustrated in FIG. 10 may cover a four feet (1.22 m) by eight feet (2.44 m) area. In some embodiments, the luminaire panel assembly 1032 can be configured to extend across a larger or smaller area, such as by changing the dimensions of each luminaire panel 1030, increasing or decreasing the number of luminaire panels 1030, changing the spacing between the cross beams 1007, and/or orienting each luminaire panels 1030 in a different direction. In some embodiments, the system 1000 can include features of the luminaire panels described herein, other luminaire panels, and/or any combination thereof.

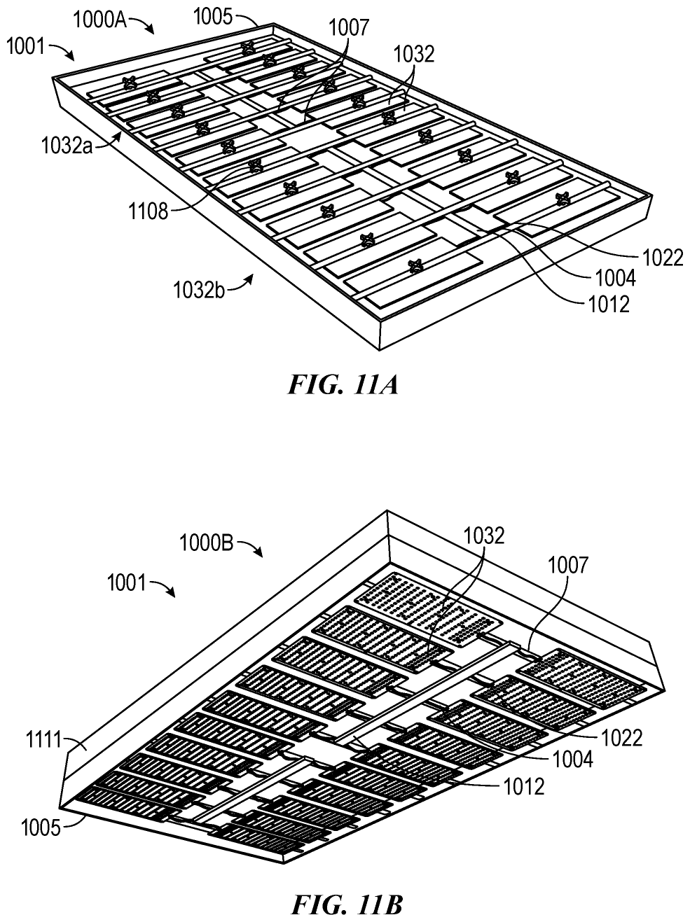

FIG. 11A is an isometric top view of the luminaire panel system 1000A of FIG. 10 installed on an upper or top layer of the vertical grow rack 1001 (partially shown) in accordance with embodiments of the present technology. Each luminaire panel 1030 is releasably mounted to a single cross beam 1003 via an releasable fastener 1108. For example, in the embodiment illustrated in FIG. 11A, the releasable fasteners 1108 are adjustable knobs. The cross beams 1007 can include T-slot channels or other structures configured to receive the releasable fasteners 1108. In some embodiments, the releasable fastener 1108 can be used to adjust and affix the angle of each luminaire panel 1032 relative to an underlying grow tray (not shown), thereby controlling the lighting conditions of the grow tray positioned below the luminaire panel system 1000A. In other embodiments, the panels 1032 can be mounted to the cross beams 1007 via other mechanisms (e.g., magnets, screws, interfacing surfaces, nuts and bolts, clips). The spine 1012 can be attached to lower sides (i.e., the underside) of one or more cross beams 1007 (as shown), attached to upper sides of one or more cross beams 1007, hang from the luminaire panels 1030 below the cross beams 1007 via the wires 1004, or rest atop one or more cross beams 1007. The wires 1004 can extend through the spine 1012 and either above or below the cross beams 1007 to electrically connect to the individual luminaire panels 1030.

In some embodiments, the luminaire panel system 1000A is installed on existing frame of side support beams 1005 (i.e., the outer peripheral beams defining the periphery of a shelf, referred to as a “shelf support frame”) already existing on a vertical grow rack. The cross beams 1007 be added to the shelf support frame and the luminaire panel assemblies 1032 can be attached thereto, allowing the user to dictate the position of the cross beams 1007 based on the desired position of the luminaire panels 1030. In some embodiments, the shelf support frame already includes the cross beams 1007 and the luminaire panels 1030 can be attached thereto. In some embodiments, the luminaire panel system 1000A includes the side support beams 1005 and the cross beams 1007, such that the entire structure (e.g., shown in FIG. 11A) can be attached to vertical supports of the grow rack at a desired height and position relative to the underlying grow tray via screws, welding, interfacing surfaces, and/or other attachment mechanisms. In this manner, the system 1000A is like a cassette or fully formed shelf that can be easily installed on vertical supports.

FIG. 11B is an isometric bottom view of the luminaire panel system 1000B of FIG. 10 for an intermediate layer of the vertical grow rack in accordance with embodiments of the present technology. The luminaire panel system 1000B includes features similar to those described above with respect to FIG. 11A, such as the connection to the cross beams 1007. However, because the luminaire panel system 1000B is for an intermediate layer of the vertical grow rack 1001, a grow tray 1111 is coupled to and/or stacked on an upper side of the side support beams 1005 (i.e., the side nearest the back side of the luminaire panels 1030). The grow tray 1111 can house or otherwise receive the soil, seeds, bulbs, plants, and/or related materials for growing plants in an indoor environment. The luminaire panel assemblies 1000B illustrated in FIG. 11B can be used to provide lighting to a grow tray (not shown) positioned below the system 1000, while the grow tray 1111 can receive lighting from another luminaire panel system 1000B positioned above the grow tray 1111. In some embodiments, the vertical grow rack 1001 can include additional layers between the side support beams 1005 and the grow tray 1111, such as an irrigation system, a nutrient managing system, a ventilation system, and/or other systems for supporting an indoor growing environment.

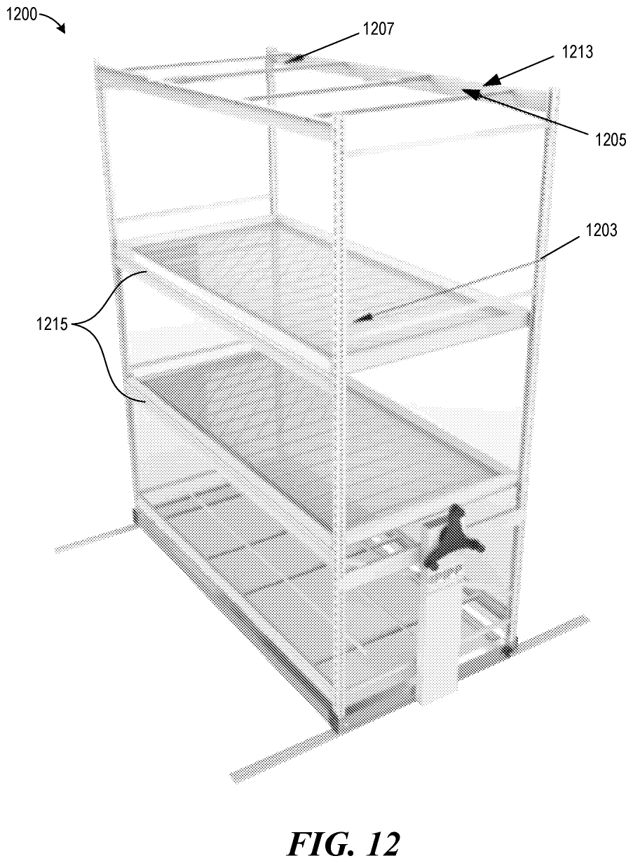

FIG. 12 is an isometric view of a vertical grow rack system 1200 configured to receive luminaire panel assemblies in in accordance with embodiments of the present technology. Similar to the vertical grow rack system described above, the vertical grow rack system 1200 includes vertical supports 1203, side support beams 1205 extending between the vertical supports 1203, and cross members 1207 extending between opposing side support beams 1205. The luminaire panel system 1000A of FIG. 11A can be positioned on the top level 1213 of the vertical grow rack system 1200 as described above with respect to FIGS. 10 and 11A, and one or more of the luminaire panel systems 1000B of FIG. 11B can be poisoned on the intermediate shelves 1215 to provide lighting to an underlying grow tray and, optionally, a grow tray that receives light from an overlying luminaire panel system 1000. In some embodiments, the vertical grow rack system 1200 already includes grow trays and, therefore, the luminaire panel systems installed on each level do not require grow trays and can all be similar to system 1000A of FIG. 11A. In some embodiments, the vertical grow rack system 1200 includes only the vertical supports 1203, and the luminaire panel system 1000A, 1000B are positioned as modular units (e.g., referred to as “cassettes”) between the four vertical supports 1203 at desired heights. In some embodiments, the vertical grow rack system 1200 includes the vertical supports 1203 and the side supports 1205, and the cross members and luminaire panel assemblies 1032 (FIGS. 10-11B) are attached thereto. Accordingly, the frameless luminaire panel systems and assemblies can provide modular, easy to install units that can utilize existing vertical grow rack frames (or portions thereof) to create a customizable, yet efficient to install system.

Any one of the proceeding embodiments and or features thereof can be combined with any of the other embodiments disclosed herein (or portions thereof),

### Further Examples

The following examples are illustrative of several embodiments of the present technology:
1. A horticulture luminaire device, comprising:
a panel frame comprising a base and sidewalls extending at a non-zero angle from the base;
a lightboard assembly coupled to the panel frame, the lightboard assembly comprising—
   a lightboard substrate with a first side coupled to the base of the panel frame and a second side opposite the first side; and
   a plurality of light components arranged in an array across the second side of the lightboard substrate, wherein the light components are configured to emit light outwardly away from the second side; and
a panel lens coupled to the second side of the lightboard substrate and disposed between the sidewalls of the panel frame, wherein the panel lens is configured to conform to the second side and the light components.
2. The device of example 1, further comprising an adhesive layer disposed between the base of the panel frame and the first side of the lightboard substrate, and between the sidewalls of the panel frame.
3. The device of example 2, wherein the adhesive layer comprises a thermal paste layer configured to transfer heat from the lightboard substrate to the panel frame.
4. The device of any one of the preceding examples, further comprising a plurality of fasteners configured to couple the lightboard substrate to the panel frame.
5. The device of any one of the preceding examples, wherein the lightboard assembly further comprises a metal back plate coupled between the first side of the lightboard substrate and the base, wherein the metal back plate is configured to transfer heat away from the lightboard substrate.
6. The device of any one of the preceding examples, wherein the panel frame and the lightboard substrate are integrally formed.
7. The device of any one of the preceding examples, wherein the panel lens comprises a translucent liquid, a polymer, or a cured resin.
8. The device of any one of the preceding examples, further comprising a controller electrically coupled to the light components through a connection port access of the base.
9. A horticulture luminaire system, comprising:
a plurality of horticulture luminaire devices, each device comprising:
   a panel frame comprising a base and sidewalls extending at a non-zero angle from the base;
   a lightboard assembly coupled to the panel frame, the lightboard assembly comprising—
      a lightboard substrate with a first side coupled to the base of the panel frame and a second side opposite the first side; and
      a plurality of light components arranged in an array across the second side of the lightboard substrate, wherein the light components are configured to emit light outwardly away from the second side; and
   a panel lens coupled to the second side of the lightboard substrate and disposed between the sidewalls of the panel frame, wherein the panel lens is configured to conform to the second side and the light components; and
a support assembly removably couplable to the horticulture luminaire devices, wherein the support assembly comprises a spine member, and wherein the support assembly is configured to support the horticulture luminaire devices on either side of the spine member.
10. The system of example 9, wherein the support assembly further comprises—
a connection port assembly coupled to the spine member and configured to provide electrical connection between a controller and the light components; and
a plurality of arm members extending away from the spine member and removably couplable to the panel frame.
11. The system of any one of the preceding examples, wherein the frame assembly further comprises an extension mechanism configured to retractably extend a length of the spine member and/or a length of one or more of the arm members.
12. The system of any one of the preceding examples, wherein the frame assembly further comprises a pivot mechanism configured to rotate the arm members and the panel frame coupled to the arm members relative to the spine member.
13. The system of any one of the preceding examples, wherein the support assembly further comprises—
a plurality of cross beams configured to mount on side support beams of a growing rack, wherein the spine member is configured to couple to the cross beams;
a wiring assembly configured to extend through the spine member and electrically connect to each of the horticulture luminaire devices; and
a plurality of fasteners, wherein each of the fasteners is configured to couple a corresponding one of the horticulture luminaire devices to one of the cross beams.
14. The system of any one of the preceding examples, wherein a first subset of the light components proximate to the spine member are arranged at a first density, wherein a second subset of the light components distant from the spine member are arranged at a second density, and wherein the first density is less than the second density.
15. A method of manufacturing a horticulture luminaire device, comprising:
providing a panel frame with a base and sidewalls extending at a non-zero angle from the base;
arranging a plurality of light components in an array across a second side of a lightboard substrate, wherein the light components are configured to emit light outwardly away from the second side;
disposing a first side of the lightboard substrate proximate to the base of the panel frame;
pouring a panel lens resin onto the second side of the lightboard substrate, wherein the panel lens resin is contained by the sidewalls of the panel frame; and
curing the panel lens resin.
16. The method of any one of the preceding examples, wherein providing the panel frame comprises:
preparing a sheet metal;
bending side portions of the sheet metal at the non-zero angle to form the sidewalls of the panel frame; and
welding the sidewalls together at one or more corners of the base.
17. The method of any one of the preceding examples, further comprising applying an adhesive layer between the panel frame and the lightboard substrate, and between the sidewalls of the panel frame.
18. The method of any one of the preceding examples, wherein the adhesive layer comprises a thermal paste layer configured to transfer heat from the lightboard substrate to the panel frame.
19. The method of any one of the preceding examples, wherein the panel frame and the lightboard substrate are integrally formed.
20. The method of any one of the preceding examples, wherein arranging the light components comprises:
arranging a first subset of the light components proximate to a first side of the lightboard substrate at a first density; and
arranging a second subset of the light components distant from the first side of the lightboard substrate at a second density,
   wherein the first density is less than the second density.

### CONCLUSION

The above detailed descriptions of embodiments of the technology are not intended to be exhaustive or to limit the technology to the precise form disclosed above. Although specific embodiments of, and examples for, the technology are described above for illustrative purposes, various equivalent modifications are possible within the scope of the technology as those skilled in the relevant art will recognize. For example, although steps are presented in a given order above, alternative embodiments may perform steps in a different order. Furthermore, the various embodiments described herein may also be combined to provide further embodiments.

From the foregoing, it will be appreciated that specific embodiments of the technology have been described herein for purposes of illustration, but well-known structures and functions have not been shown or described in detail to avoid unnecessarily obscuring the description of the embodiments of the technology. Where the context permits, singular or plural terms may also include the plural or singular term, respectively. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “or” as in “A or B” refers to A alone, B alone, and both A and B, unless the context specifically shows otherwise. Additionally, the terms “comprising,” “including,” “having,” and “with” are used throughout to mean including at least the recited feature(s) such that any greater number of the same features or additional types of other features are not precluded. Directional terms, such as “upper,” “lower,” “front,” “back,” “vertical,” and “horizontal,” may be used herein to express and clarify the relationship between various elements. It should be understood that such terms do not denote absolute orientation. Reference herein to “one embodiment,” “an embodiment,” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments.

From the foregoing, it will also be appreciated that various modifications may be made without deviating from the disclosure or the technology. For example, one of ordinary skill in the art will understand that various components of the technology can be further divided into subcomponents, or that various components and functions of the technology may be combined and integrated. In addition, certain aspects of the technology described in the context of particular embodiments may also be combined or eliminated in other embodiments. Furthermore, although advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

I/We claim:

1. A horticulture luminaire device, comprising:
a panel frame comprising a base and sidewalls extending at a non-zero angle from the base;
a lightboard assembly coupled to the panel frame, the lightboard assembly comprising—
a lightboard substrate with a first side coupled to the base of the panel frame and a second side opposite the first side; and
a plurality of light components arranged in an array across the second side of the lightboard substrate, wherein the light components are configured to emit light outwardly away from the second side; and
a panel lens coupled to the second side of the lightboard substrate and disposed between the sidewalls of the panel frame, wherein the panel lens is configured to conform to the second side and the light components.

2. The device of claim 1, further comprising an adhesive layer disposed between the base of the panel frame and the first side of the lightboard substrate, and between the sidewalls of the panel frame.

3. The device of claim 2, wherein the adhesive layer comprises a thermal paste layer configured to transfer heat from the lightboard substrate to the panel frame.

4. The device of claim 1, further comprising a plurality of fasteners configured to couple the lightboard substrate to the panel frame.

5. The device of claim 1, wherein the lightboard assembly further comprises a metal back plate coupled between the first side of the lightboard substrate and the base, wherein the metal back plate is configured to transfer heat away from the lightboard substrate.

6. The device of claim 1, wherein the panel frame and the lightboard substrate are integrally formed.

7. The device of claim 1, wherein the panel lens comprises a translucent liquid, a polymer, or a cured resin.

8. The device of claim 1, further comprising a controller electrically coupled to the light components through a connection port access of the base.

9. A horticulture luminaire system, comprising:
a plurality of horticulture luminaire devices, each device comprising:
a panel frame comprising a base and sidewalls extending at a non-zero angle from the base;
a lightboard assembly coupled to the panel frame, the lightboard assembly comprising—
a lightboard substrate with a first side coupled to the base of the panel frame and a second side opposite the first side; and
a plurality of light components arranged in an array across the second side of the lightboard substrate, wherein the light components are configured to emit light outwardly away from the second side; and
a panel lens coupled to the second side of the lightboard substrate and disposed between the sidewalls of the panel frame, wherein the panel lens is configured to conform to the second side and the light components; and
a support assembly removably couplable to the horticulture luminaire devices, wherein the support assembly comprises a spine member, and wherein the support assembly is configured to support the horticulture luminaire devices on either side of the spine member.

10. The system of claim 9, wherein the support assembly further comprises—
a connection port assembly coupled to the spine member and configured to provide electrical connection between a controller and the light components; and
a plurality of arm members extending away from the spine member and removably couplable to the panel frame.

11. The system of claim 10, wherein the frame assembly further comprises an extension mechanism configured to retractably extend a length of the spine member and/or a length of one or more of the arm members.

12. The system of claim 10, wherein the frame assembly further comprises a pivot mechanism configured to rotate the arm members and the panel frame coupled to the arm members relative to the spine member.

13. The system of claim 9, wherein the support assembly further comprises—
a plurality of cross beams configured to mount on side support beams of a growing rack, wherein the spine member is configured to couple to the cross beams;
a wiring assembly configured to extend through the spine member and electrically connect to each of the horticulture luminaire devices; and
a plurality of fasteners, wherein each of the fasteners is configured to couple a corresponding one of the horticulture luminaire devices to one of the cross beams.

14. The system of claim of 9, wherein a first subset of the light components proximate to the spine member are arranged at a first density, wherein a second subset of the light components distant from the spine member are arranged at a second density, and wherein the first density is less than the second density.

15. A method of manufacturing a horticulture luminaire device, comprising:
providing a panel frame with a base and sidewalls extending at a non-zero angle from the base;
arranging a plurality of light components in an array across a second side of a lightboard substrate, wherein the light components are configured to emit light outwardly away from the second side;
disposing a first side of the lightboard substrate proximate to the base of the panel frame;
pouring a panel lens resin onto the second side of the lightboard substrate, wherein the panel lens resin is contained by the sidewalls of the panel frame; and
curing the panel lens resin.

16. The method of claim 15, wherein providing the panel frame comprises:
preparing a sheet metal;
bending side portions of the sheet metal at the non-zero angle to form the sidewalls of the panel frame; and
welding the sidewalls together at one or more corners of the base.

17. The method of claim 15, further comprising applying an adhesive layer between the panel frame and the lightboard substrate, and between the sidewalls of the panel frame.

18. The method of claim 17, wherein the adhesive layer comprises a thermal paste layer configured to transfer heat from the lightboard substrate to the panel frame.

19. The method of claim 15, wherein the panel frame and the lightboard substrate are integrally formed.

20. The method of claim 16, wherein arranging the light components comprises:
arranging a first subset of the light components proximate to a first side of the lightboard substrate at a first density; and
arranging a second subset of the light components distant from the first side of the lightboard substrate at a second density,
wherein the first density is less than the second density.
